(19) United States
(12) Patent Application Publication
(10) Pub. No.: US 2011/0247440 A1
(43) Pub. Date: Oct. 13, 2011

(54) WORM GEAR CLUTCH MECHANISM

(76) Inventor: William Lyle Warke, Ballymoney (GB)

(21) Appl. No.: 13/127,115

(22) PCT Filed: Nov. 2, 2009
(86) PCT No.: PCT/GB2009/002589

§ 371 Date: Jun. 7, 2011

(30) Foreign Application Priority Data
Oct. 31, 2008 (GB) 0820001.6

(51) Int. Cl. F16H 57/00; F16H 1/16

(52) U.S. Cl. 74/405

(57) ABSTRACT

A worm gear clutch mechanism comprising a worm shaft (10), an output shaft (16) having a worm wheel (11), and means to move the worm shaft relative the worm wheel, the worm shaft being movable about a tilt axis that is substantially perpendicular to the longitudinal axis of said worm shaft (10) so that the worm shaft is movable into and out of engagement with the worm wheel.

The present invention relates to a mechanism for the provision of a positive drive engagement and disengagement means suitable for slow turning high torque driveshafts for any application where it would be desirable to disconnect a driveshaft from a drive train to enable the driveshaft to freely rotate.

Worm drive gearboxes have long been recognised as the most common and compact method to achieve high ratio speed reductions. An axis of the worm gear shaft is positioned perpendicular to a worm gear wheel and at a fixed and precise distance to provide accurate engagement of a worm of the worm gear shaft with gear teeth of the worm gear wheel. The worm is a spiral groove which is machined into a portion of the worm gear shaft, the worm or groove engaging with corresponding teeth on the worm gear wheel. Rotation of the worm gear shaft propels the teeth on the worm gear wheel along the pitch of the worm, thus rotating the worm gear wheel about its axis. Limitless speed reductions can be achieved by altering the worm shaft and worm wheel diameters in conjunction with the worm screw pitch distance and the number of gear teeth in the worm gear wheel. In a traditional worm drive gearbox, the worm gear shaft and the worm gear wheel normally rotate on bearings which are fixed within the body of the gear housing and therefore the gears are constantly engaged with no means of disengagement. The compact nature of a worm drive gearbox as a means to achieve high ration speed reductions makes it a popular choice for a wide rang of industrial and commercial applications however many of these applications would benefit from a means of engaging and disengaging the drive. One such application would be a pedestrian operated machine whereby the high ration speed reduction provides a slow turning wheel axle which enables the machine to be propelled at walking pace however it would be extremely beneficial if a means for disengaging the worm gear wheel from the worm shaft drive was provided so as to enable the machine to be wheeled freely by an operator. Worm drive gearboxes are available which incorporate various forms of disengagement mechanisms however these tend to be overly complicated and/or limited in their application. U.S. Pat. No. 6,237,863 discloses a worm wheel gearbox comprising a worm disposed on a driveshaft, the worm engaging a bull gear within the gearbox. The driveshaft is mounted on a pair of eccentric mounts such that rotation of the mounts effects the engagement and disengagement of the worm from the bull gear.

It is therefore an object of the present invention to obviate or mitigate the above problem by providing a worm gear clutch mechanism having an engagement and disengagement facility which is versatile in operation, inexpensive to produce and lends itself to a wide range of applications. In the forgoing description it will be understood that the terms “worm shaft’ and ‘worm gear shaft’ refer to the same part and so are used interchangeably.

Accordingly, the present invention provides a worm gear clutch mechanism comprising a worm shaft and an output shaft having a worm wheel, the worm shaft being movable about a tilt axis that is substantially perpendicular to the longitudinal axis of said worm shaft, so that the worm is movable into and out of engagement with the worm wheel.

Conveniently, activation means is provided proximate the worm so that said worm can be controllably brought into and out of engagement with the worm wheel.

Advantageously, the tilt axis may be located within or externally of a gearbox casing which encases the clutch mechanism, dependent on the proposed use of the mechanism.

Preferably, the worm shaft is carried in a worm arm.

Preferably, the worm arm comprises two spaced apart parallel side walls secured together at each of their respective ends with the shaft carried between the two end walls and parallel to the two sides.

Alternatively, the worm arm may comprise one side wall or may comprise a tubular member through which the input driveshaft extends.

Alternatively also, the worm arm at the end or near to the outer end of the driveshaft has an engagement adjuster screw mounted therebelow to rest on an engagement axle when the worm wheel and worm shaft are disengaged. An engagement lobe is desirably provided on the axle to engage the adjuster screw when the axle is rotated.

Preferably, the worm shaft is mounted eccentrically at one end in a rotatable engagement coupling that is movable so as to bring the worm shaft into and out of engagement with the worm gear wheel.

Other aspects of the invention are defined in the appended claims which are incorporated into the description by way of reference.

Embodiments of the present invention will now be described, by way of example, with reference to the accompanying drawings, in which:—

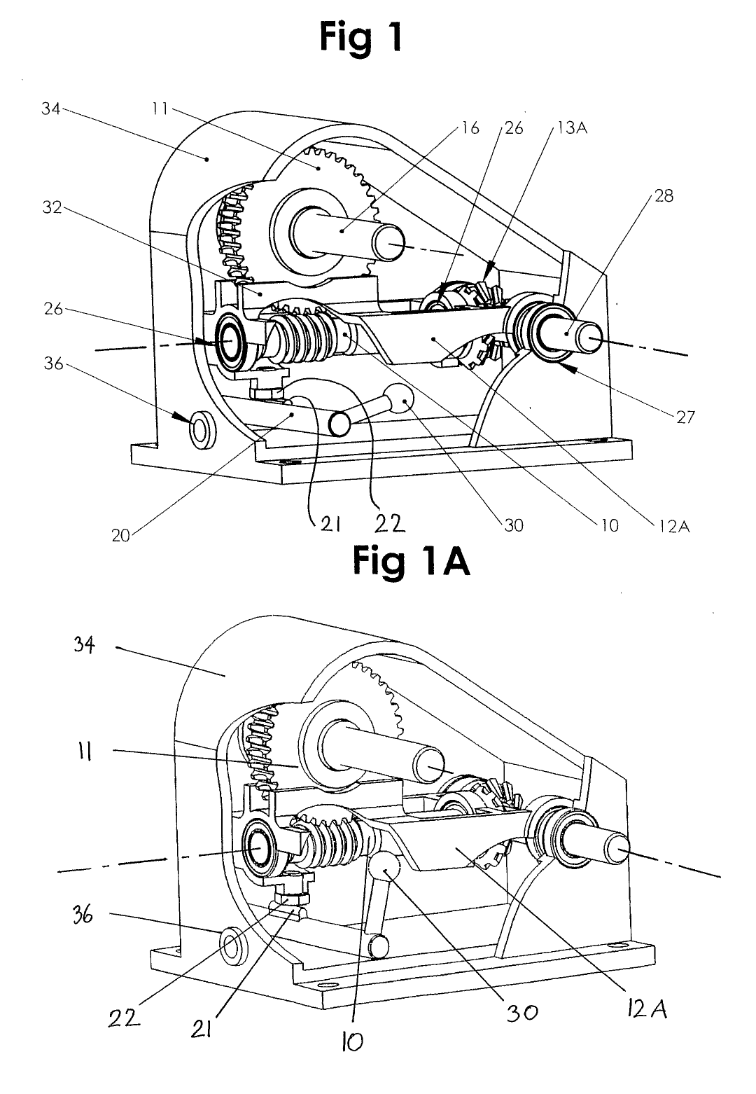

FIGS. 1 and 1A are each a perspective view from one side and one end of a worm drive gearbox having a gear clutch mechanism according to a first embodiment of the present invention in which a worm shaft is shown disengaged (FIG. 1) and engaged (FIG. 1A) respectively from a worm wheel, with an engagement axle shown in a disengaged and an engaged position respectively, part of a casing of the gearbox being cut-away for clarity;

FIG. 1B is a perspective view from the same side, an opposite end and underneath from that shown in FIGS. 1 and 1A of the worm drive gearbox with the complete casing removed and the engagement axle in a disengaged position;

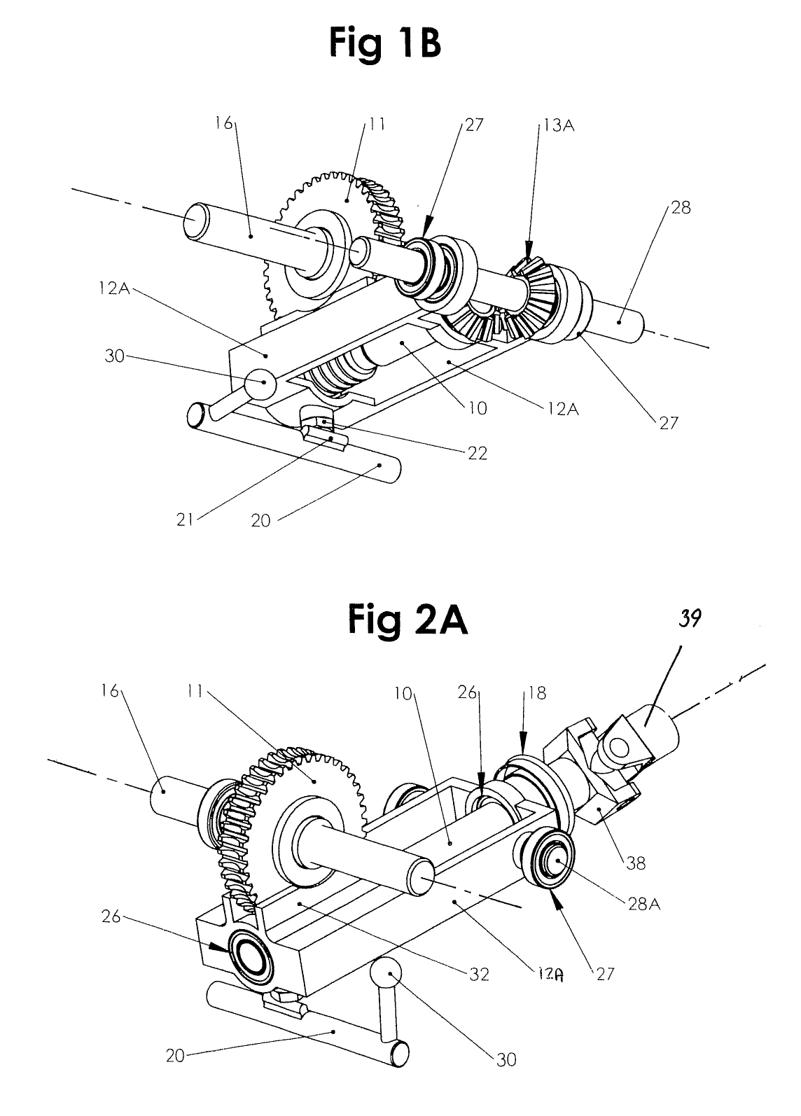

FIG. 2 is a perspective view from one side and one end of the gearbox according to a second embodiment shown with the worm shaft and the worm wheel being engaged with the engagement axle in an engaged position and a universal joint being shown outside the casing as part of an input drive shaft coupled to the worm shaft;

FIG. 2A is a second perspective view of the gearbox shown in FIG. 2 but with the casing removed for clarity;

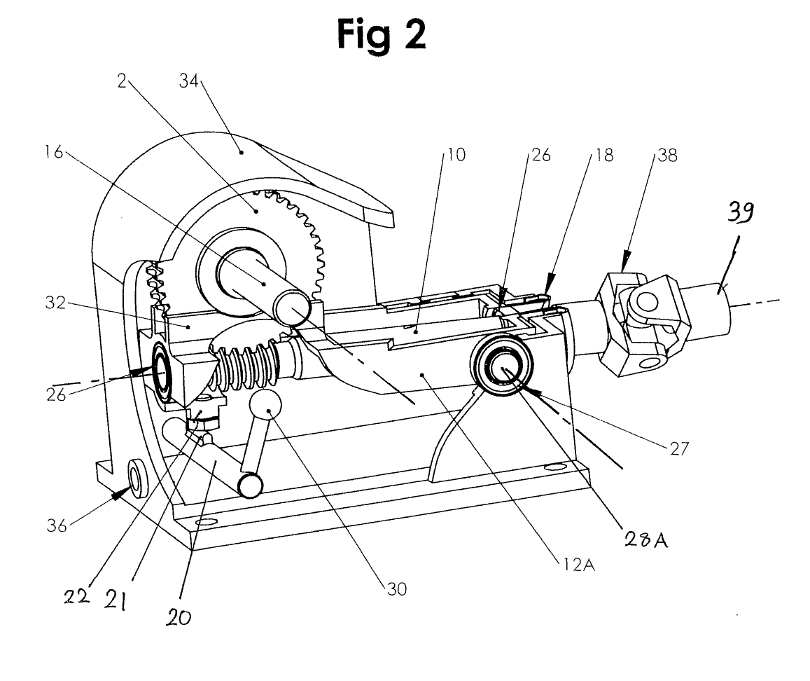

FIGS. 3 and 3A are each perspective views of a gearbox according to a third embodiment in which the universal joint shown in FIGS. 2 and 2A is positioned internally of the casing, with the engagement axle shown in an engaged and a disengaged position respectively, part of a casing of the gearbox being cut-away for clarity;

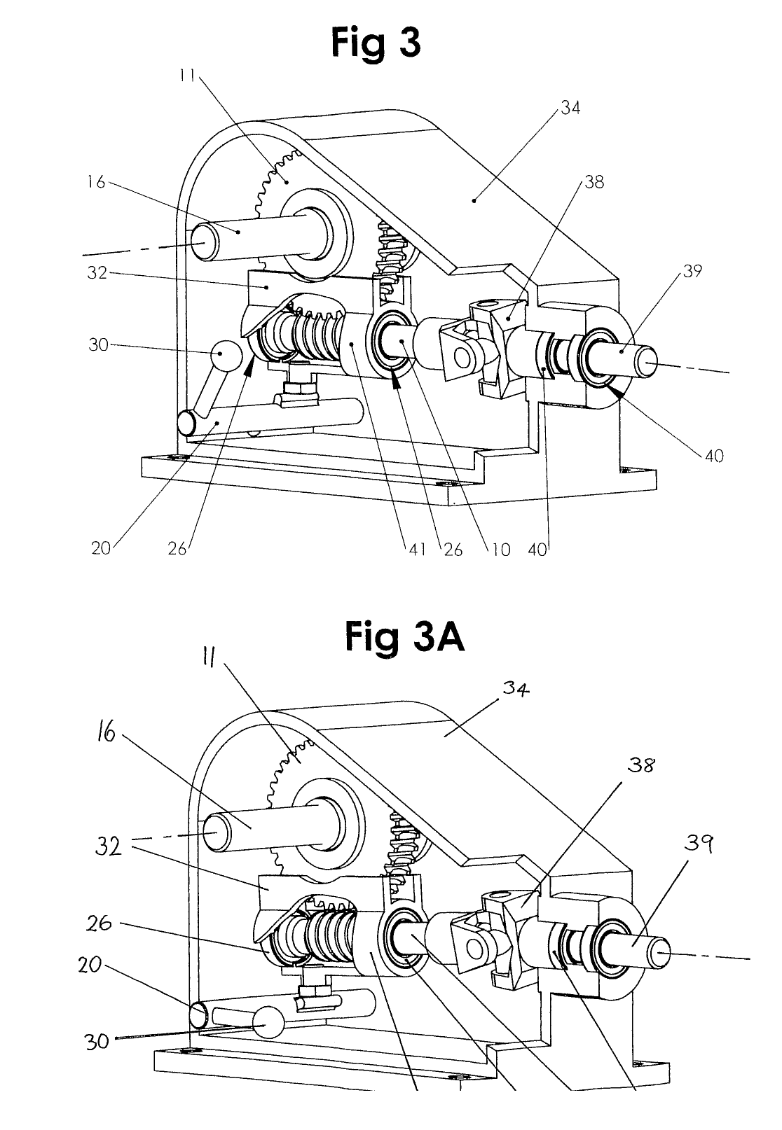

FIG. 4 is a perspective view of the gearbox according to a fourth and preferred embodiment in which the worm shaft is extended beyond the worm gear wheel and mounted eccentrically in a rotatable engagement coupling, the worm wheel and worm shaft being shown engaged, the universal joint being positioned internally of the casing, part of the casing of the gearbox being cut-away for clarity;

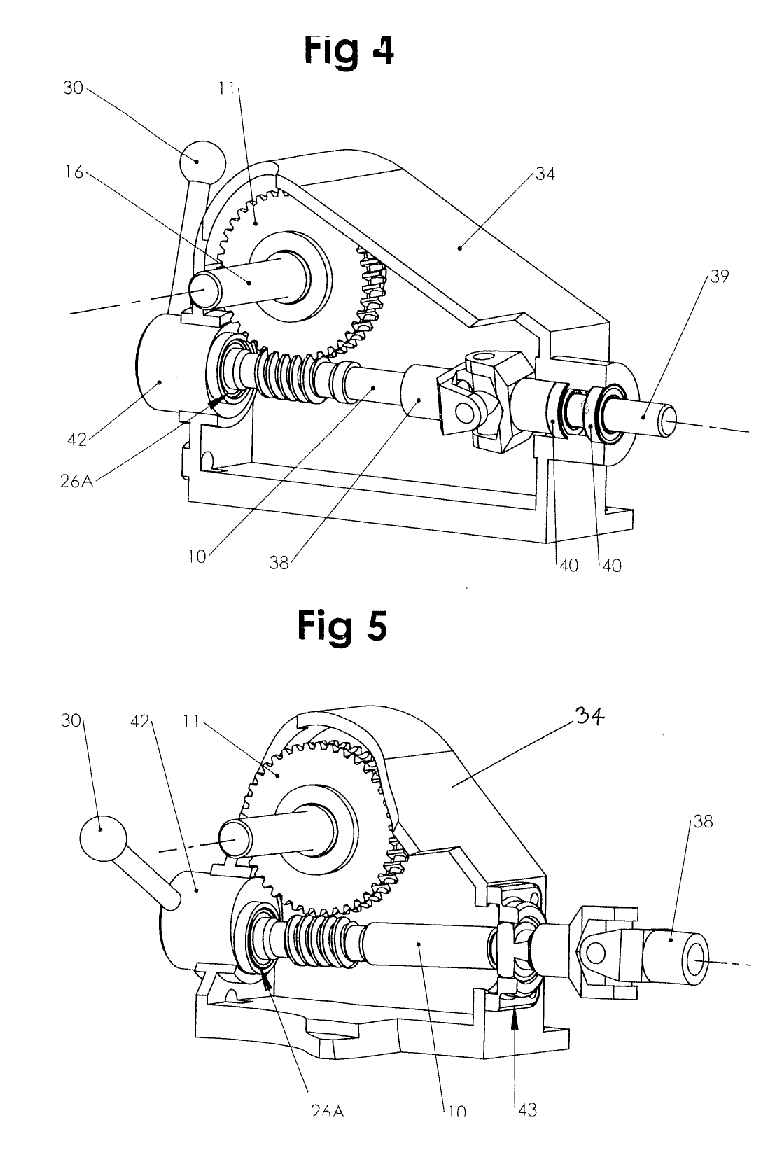

FIG. 5 is a perspective view of the gearbox according to a fifth embodiment, the gearbox being similar to that shown in FIG. 4 but with the universal joint positioned outside the gearbox and with the worm wheel and worm shaft disengaged;

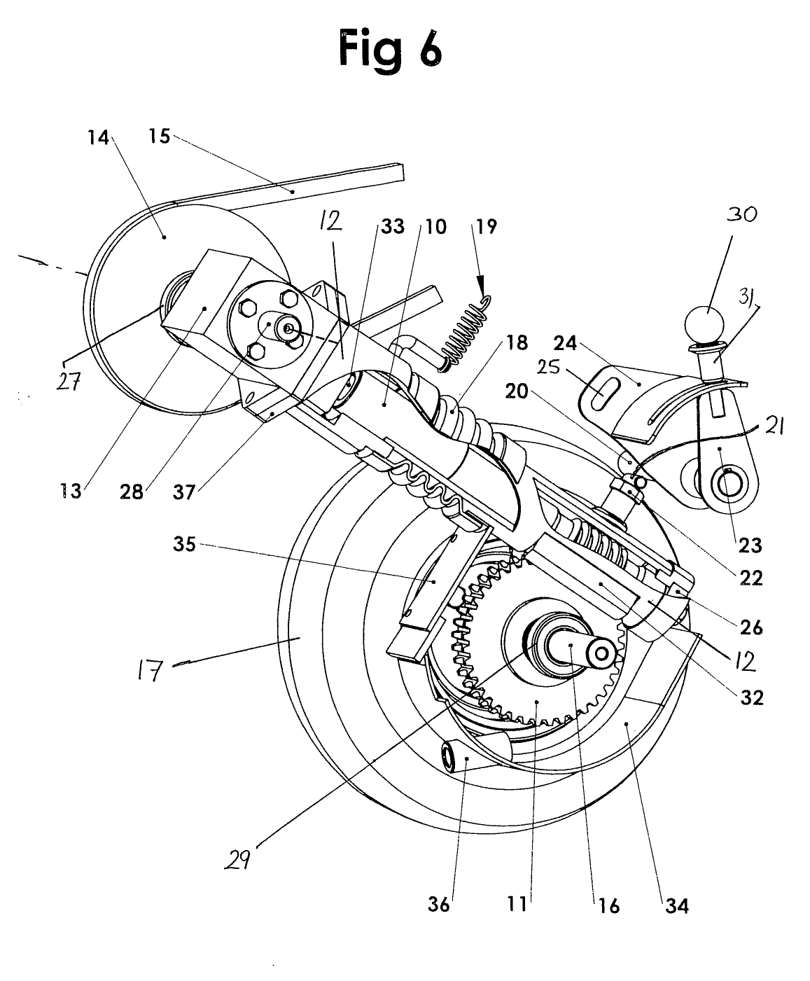

FIG. 6 is a perspective view of the gearbox as per the first embodiment to a larger scale and shown customised for use on a pedestrian operated machine;

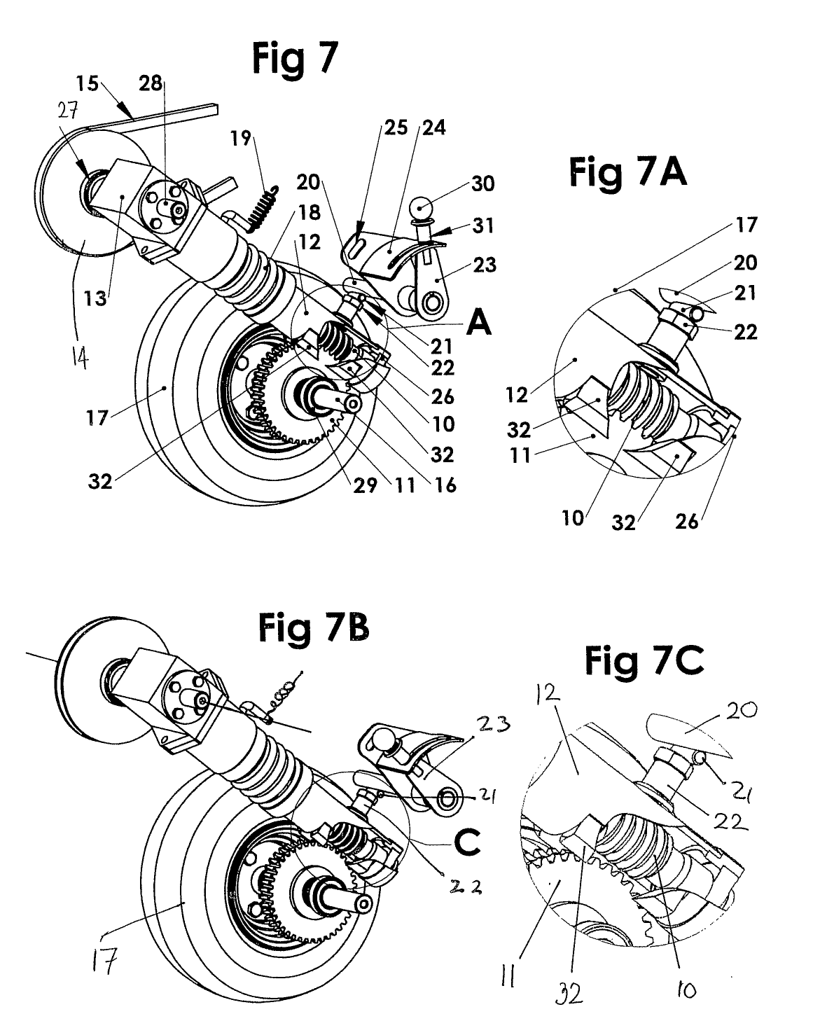

FIG. 7 is a perspective view of the gearbox of FIG. 6 shown with the worm engaged and with part of an extended worm arm being cut-away for clarity;

FIG. 7A is a detailed view of FIG. 7;

FIG. 7B is a perspective view of the gearbox of FIG. 6 shown with the worm disengaged and with part of an extended worm arm being cut-away for clarity; and

FIG. 7C is a detailed view of FIG. 7B.

Referring to the drawings, a worm gear clutch mechanism includes an output shaft 16 having a worm wheel 11 and a worm gear shaft 10, the worm gear shaft being movable about a tilt axis that is substantially perpendicular to its longitudinal axis and which is located at a position remote from the output shaft 16 so that the worm can be moved into and out of engagement with the worm wheel. Means to move the worm shaft into and out of engagement with the worm gear wheel 11 are provided proximate the worm. The tilt axis of the worm shaft can be located within or external of a gearbox casing encasing the mechanism depending on the proposed use of the mechanism.

With reference to FIG. 1 and FIG. 1B, the mechanism according to the first embodiment comprises a worm gear shaft 10 cradled within a worm arm 12A and supported at either end by a radial thrust bearing 26. The worm arm is pivotally attached via gearbox cross-shaft bearings 27 to an input driveshaft in the form a gearbox cross-shaft 28 which extends from a suitable drive means or motor. Input drive is transferred from the gearbox cross-shaft 28 to the worm gear shaft 10 via bevel gears 13A one of which is fixed to the end of the worm gear shaft and the other on the centre portion of the gearbox cross-shaft between the said gearbox cross-shaft bearings. Means to move the worm gear shaft 10 into engagement with worm wheel 11 comprises an engagement axle 20 rotation of which via an engagement lever 23 causes worm arm 12A to tilt about a longitudinal axis of the gearbox cross-shaft axis raising and lowering the worm arm 12A by virtue of a engagement lobe 21 which acts like a cam in contact with an engagement adjuster screw 22. The tilting movement of the worm arm 12A engages and disengages the worm gear shaft 10 from the worm gear wheel 11 as illustrated in FIG. 1A and FIG. 1, respectively. When the worm gear wheel 11 and worm shaft 10 are engaged, lateral movement of the worm gear shaft in relation to the worm gear wheel is prevented by a lateral support pad 32 which is fixed to the worm arm 12A on either side of, and in contact with, worm gear wheel 11. As shown in FIGS. 1, 1A and 2, the gearbox casing 34 is provided with a drain hole 36.

The worm gear shaft 10 tilt principle of engaging and disengaging the worm gear shaft from the worm gear wheel can also be applied to a “Tee-drive” gearbox whereby the input drive shaft 39, which is substantially in-line with the worm shaft to which it is coupled via universal joint 38, forms a T-shape with the output shaft 16 as illustrated in FIG. 2 and FIG. 2A. With reference to FIG. 2 and FIG. 2A which shows a second embodiment and in which like parts are denoted by like numerals the gearbox cross-shaft 28 and bevel gears 13A have been removed. The gearbox cross-shaft has been replaced by cross stub axle 28A about whose longitudinal axis worm arm 12A tilts by virtue of gearbox cross-shaft bearings 27. The input drive via drive shaft 39 to the tilting worm shaft 10 is provided by universal drive coupling 38 with a seal between tilting worm arm 12A and the gearbox casing 34 provided by flexible seal 18.

As illustrated in FIGS. 3, 4 and 5, the third, fourth and fifth embodiments are further examples of the tilting worm gear shaft clutch principle when applied to a “Tee-drive” gearbox. Again, like parts are denoted by like numerals. With reference to FIG. 3 and FIG. 3a, the worm gear shaft tilt axis is provided by a universal drive coupling 38 which has been incorporated between tee driveshaft 39 and worm gear shaft 10. Worm arm 12A has been replaced by a worm saddle 41 which extends over the worm portion of the worm shaft and which contains a radial thrust bearing 26 at each end on which the worm shaft rotates. Lateral support pads 32 and engagement adjuster screw 22 are attached to the said worm saddle in the same manner and for the same purpose as on the worm arm 12A. Rotation of engagement axle 20 via engagement lever 30 causes the worm gear shaft 10 to tilt about an axis of universal drive coupling 38 thereby raising and lowering the worm saddle 41 to facilitate engagement and disengagement of worm shaft 10 with the worm wheel 11. Tee input driveshaft 39 rotates about its axis by virtue of driveshaft bearings 40 which are contained in the gearbox casing 34 and provide a non-tilting input drive for the tee drive gearbox.

Various mechanisms can be used to tilt the worm gear shaft to engage and disengage drive. With reference to FIG. 4, an eccentric housing 42 contains a self aligning radial bearing 26A which is provided on the end of worm gear shaft 10. The outside diametric surface of eccentric housing 42 is offset from the self aligning radial bearing contained within. The outside diametric surface is located and supported by gearbox casing 34 so when the eccentric housing is rotated by means of engagement lever 30, the worm gear shaft is moved in an arc so as to engage and disengage worm gear wheel 11 as shown in FIG. 4 and FIG. 5, respectively.

With reference to FIG. 5, the worm gear shaft 10 is shown extending through a self aligning bearing block 43 which is fixed to the gearbox casing 34. Self-aligning bearing block 43 provides the pivot point for the worm gear shaft to enable engagement and disengagement with the worm gear wheel when the universal joint is located external to the casing 34. The ball-joint characteristics of the universal drive coupling 38 and the self aligning bearing block 43 enable the arcuate movement imparted by eccentric housing 42 at the opposite end of the worm gear shaft 10 to tilt the said worm gear shaft to engage and disengage drive. Input drive to the tilting worm gear shaft 10 is provided by driveshaft 39 which couples to worm shaft 10 via universal drive coupling 38 as illustrated in FIG. 5, the universal coupling shown located externally of the gearbox casing 34.

Parallel drive gearboxes such as illustrated in FIG. 1 provide a reduced speed output gear wheel axle 16 running parallel with an input drive gearbox cross-shaft 28. The gearbox cross-shaft 28 can also be utilised as a non-reduced speed output or auxiliary driveshaft. The distance between the cross-shaft 28 and the output shaft 16 can be altered by extending worm gearbox casing 34, worm gear shaft 10 and/or worm arm 12A as applicable. This extension could be utilised for example, in a ground working machine application, to enable the auxiliary driveshaft to power an implement or cutter blade located some distance from the gear wheel axle which would be used to power the ground engaging drive wheels. For some applications it may be desirable to allow the worm gearbox casing 34 to pivot about the longitudinal axis of the input gearbox cross-shaft 28 independent of the chassis in which the gearbox cross-shaft is contained. The gear wheel axle 16 would be moveably suspended in an arc about the input drive gearbox cross-shaft 28 axis, for example, to form a suspension arm providing drive via gear wheel axle 16 to a ground engaging wheel or wheels. The input gearbox cross-shaft 28 and the gear wheel axle 16 can also be housed in separate casings. This arrangement would facilitate, for example, the worm gearbox casing 34 to move or swivel about gear wheel axle 16 independently of the input drive gearbox cross-shaft 28 and the chassis in which the said gearbox cross-shaft is contained. In such cases the worm gear shaft 10 pivot axis or point would be external of the said worm gearbox casing 34. With reference to FIG. 1, gearbox cross-shaft 28 complete with bevel gears 13A and associated bearings could be housed separately within their own casing apart from worm gearbox casing 34.

The following description and referenced illustrations relate to an extended worm arm arrangement in accordance with the present invention. The worm gear shaft 10 tilt axis is external to the worm gearbox casing 34. An application described below demonstrates the advantages of such an arrangement. This mechanism provides a positive drive engagement and disengagement means for slow turning high torque drives such as a ground engaging drive axles for pedestrian operated ground working machines such as turf cutters, garden cultivators or grass cutting machinery. The aforementioned mechanism provides a driving means for the ground engaging wheels and an auxiliary driving means for cultivator tines or cutter blades provided on the ground working machine. The problem for such applications is that the power source is generally provided by an engine or motor having an output shaft speed in excess of 2000 rpm. The drive train which couples this power source to the drive axle for a typical ground engaging application such as a wheel axle must reduce the speed to around 50 rpm.

For most applications of this nature it is desirable that the drive train is compact and incorporates a means of disengaging the drive, for example, to enable the operator to wheel the machine unrestrictedly without any resistance or drag from the speed reduction drive train or disengaging means. Clutches are readily available to disengage the driving means from the ground engaging application such as centrifugal, disc or loose belt clutches. These clutches are best suited to high speed low torque applications and as such are usually incorporated at the engine or power source shaft leaving the ground engaging axle connected to the speed reduction drive train. This creates drag or resistance and therefore free-wheeling is impaired. High torque clutches are available which would be suitable for incorporating into a wheel axle such as a dog-clutch or plunger-pin drive; these will cope with the high torque requirements and provide unrestricted free wheeling when disengaged but they have other limitations. For example, they tend to be difficult to engage and disengage especially under load and they offer no means of speed reduction. The mechanism described as follows addresses all of the aforementioned problems and provides a positive high torque engagement, zero drag disengagement and limitless speed reductions eliminating the need for any form of reduction drive train.

With reference to FIG. 6, worm gear shaft 10 is driven by cross-shaft 28 via right angle bevel gearbox 13 and right angle shaft 33 which extends therefrom. The worm gear shaft 10 is housed within an extended worm arm 12 which is rigidly attached by extended worm arm flange 37 at its uppermost end to the said right angle bevel gearbox 13. The right angle gearbox 13 is free to pivot about its axis on gearbox cross-shaft 28 which is supported at either side by gearbox cross-shaft bearing 27 on which the gearbox cross-shaft rotates. Bearing 27 is located and supported by a main chassis which, for clarity, is not shown in the Figures. Gear wheel axle 16 rotates on wheel axle bearing 29 which is housed within the worm gearbox casing 34. The worm gearbox casing 34 can be firmly fixed or pivotally attached to the main chassis. The worm gear shaft 10 is connected to and is driven by the gearbox right angle shaft 33 and is supported at its lower end by radial thrust bearing 26. Radial thrust bearing 26 is provided at the lowermost end of extended worm arm 12 and provides radial and linear stability to the lower end of the worm gear shaft. The pivoting action of the right angle gearbox 13 enables worm gear shaft 10 to engage and disengage with worm gear wheel 11. When worm gear wheel 11 and worm gear shaft 10 are engaged, lateral movement of the extended worm arm 12 relative the worm gear wheel 11 is prevented by lateral support pad 32 one of which is fixed to the extended worm arm 12 on either side and in contact with worm gear wheel 11. Lubrication of the pads 32 as they contact gear wheel 11 is provided by lubrication oil within the gearbox casing 34. Engagement and disengagement is implemented by rotating engagement axle 20 via engagement lever 23. Engagement lobe 21 fixed to the said engagement axle acts like a cam in contact with the end of engagement adjuster screw 22 which is adjustably attached to the said extended worm arm 12. Extended worm arm 12 is pushed at its lowermost portion by the rotation of the said engagement axle and swings in an arc about the axis of gearbox cross-shaft 28 towards the gear wheel axle 16 engaging the worm gear shaft 10 with worm gear wheel 11. The engaged worm gear clearance is set by extending or contracting the engagement adjuster screw 22.

With reference to FIG. 6, engagement lever 23 is held in the engaged position by a spring bias means (not shown) within the engagement lever plunger 31 which encircles and slides on the engagement lever stem and locates into a recess or cut-out in engagement bracket 24. Disengagement is actuated by grasping the engagement lever knob 30 and the engagement plunger 31 on an uppermost portion until it clears the recess or cut-out in engagement bracket 24. Engagement lever is then free to pivot downwards as illustrated in FIG. 7B to rotate the engagement axle 20 thereby moving the engagement lobe 21 in an arc away from the engagement adjuster screw 22. This allows the extended worm arm 12 to swing away from the worm gear wheel 11 assisted by worm arm spring 19 thereby releasing the gear wheel axle 16 and ground engaging wheel 17 to freely rotate. The engagement bracket 24 pivots on engagement axle 20 and is anchored to the main chassis by an adjustment clamp bolt (not shown) which is located through fine adjustment slot 25. Fine adjustment of the engaged worm gear clearance can easily be set externally for initial set-up and, to compensate for wear, by slackening the adjustment clamp bolt thereby enabling engagement bracket 24 to slide in an arc along the fine adjustment slot 25. In doing so, engagement bracket is rotated about the longitudinal axis of the engagement axle axis thus altering the position of the engagement lobe 21 and thereby the worm-gear clearance. The engagement adjuster screw 22 is held in contact with engagement lobe 21 by worm arm spring 19. When the engagement lever 25 is set to the disengaged position as shown in FIG. 7B, the worm arm spring 19 ensures that the engagement adjuster screw is held in contact with the engagement lobe 21 thereby maintaining adequate distance between worm gear shaft 10 and the worm gear wheel 11 to ensure that the ground engaging wheel 17 is free to rotate. Right angle bevel gearbox 13 is driven by a suitable power source not shown by input drive belt 15 and input drive pulley 14 which is fixed to the input end of the gearbox cross-shaft 28. Power is transmitted via the right angle bevel gearbox 13 to the worm gear shaft 10 which in turn, when engaged, drives the gear wheel axle 16. A sprocket or pulley (not shown) can be fixed to the output end of the said gearbox cross-shaft opposite to the input drive pulley to provide an auxiliary drive for implements or attachments such as the cutter blade for a grass or turf cutter machine or the tine shaft for a garden cultivator. Worm gear wheel 11 and the lower portion of the extended worm arm 12 are enclosed within worm gearbox casing 34. The worm gearbox casing 34 contains a lubricant such as oil or grease to lubricate the moving components within. The extended worm arm 12 protrudes through a cavity opening in the uppermost in use portion of the worm gearbox casing. The cavity opening is sealed by gearbox casing cover 35. Flexible seal 18 is attached at its uppermost end to the extended worm arm 12 and at its lower end to the sealed casing cover 35 thus preventing dirt or dust entering worm gearbox casing 34. The flexible seal 18 is adapted to enable the extended worm arm 12 to move unrestrictedly in order to engage and disengage the worm gears shaft with the worm gear wheel. The flexible seal 18 also enables the worm gearbox casing 34 to pivot about gear wheel axle 16 independently of the main chassis. This arrangement would facilitate, for example, a second wheel axle spaced apart from the gear wheel axle within the pivoting worm gear casing. Pivoting of the worm gearbox casing 34 independent of the main chassis provides a means of raising and lowering the said second wheel axle relative to the main chassis to facilitate cultivator tine or cutter depth adjustment.

It is envisaged that other layout combinations can be configured to suit many applications and there are other alternative ways of providing a tilt point or axis so that the worm gear shaft and mechanisms can engage and disengage a worm gear shaft from a worm gear wheel without departing from the present worm gear tilt clutch principle.

It is thought that the present invention and its advantages will be understood from the foregoing description and it will be apparent that various changes may be made thereto without departing from the scope of the invention as defined in the appended claims, the forms hereinbefore described being merely preferred or exemplary embodiments thereof.

1. A worm gear clutch mechanism, comprising:
a worm shaft and an output shaft having a worm wheel, the worm shaft being movable about a tilt axis that is substantially perpendicular to the longitudinal axis of said worm shaft, the worm shaft being provided with moving means so that it is movable into and out of engagement with the worm wheel.

2. A worm gear clutch mechanism as claimed in claim 1, wherein the tilt axis about which the worm shaft tilts is provided within a gearbox casing which substantially encases the worm shaft and the worm wheel.

3. A worm gear clutch mechanism as claimed in claim 1, wherein the tilt axis about which the worm shaft tilts is provided externally from a gearbox casing which substantially encases the worm shaft and the worm wheel.

4. A worm gear clutch mechanism as claimed in claim 2, wherein the tilt axis about which the worm shaft tilts is provided by a universal joint or universal coupling.

5. A worm gear clutch mechanism as claimed in claim 1, wherein the tilt axis about which the worm shaft tilts is provided by an input driveshaft.

6. A worm gear clutch mechanism as claimed in claim 1, wherein the tilt axis about which the worm shaft tilts is provided by a bearing mounted stub axle.

7. A worm gear clutch mechanism as claimed in claim 5, wherein a longitudinal axis of the input driveshaft is arranged parallel to a longitudinal axis of the output shaft to which the worm wheel is mounted.

8. A worm gear clutch mechanism as claimed in claim 4, wherein the drive to the worm shaft is provided by an input driveshaft which is coupled to said worm shaft via the universal joint or universal coupling.

9. A worm gear clutch mechanism as claimed in claim 5, wherein the worm shaft is cradled within a worm arm, the worm arm being pivotally movable about the tilt axis.

10. A worm gear clutch mechanism as claimed in claim 9, wherein the worm shaft is provided with a worm saddle which extends over the worm portion of said worm shaft.

11. A worm gear clutch mechanism as claimed in claim 10, wherein the worm arm or worm saddle is provided with spaced apart support pads which are located at each side of the worm wheel against which they contact so as to prevent lateral movement of the worm wheel when it is engaged with the worm shaft.

12. A worm gear clutch mechanism as claimed in claim 1, wherein the moving means to move the worm shaft into and out of engagement with the worm wheel comprises an engagement axle, the engagement axle comprising cam means which acts on the worm shaft so as to affect tilting movement of said worm shaft about its tilting axis.

13. A worm gear clutch mechanism as claimed in claim 12, wherein the cam means comprises an engagement lobe which contacts the worm arm in which the worm shaft is cradled or the worm saddle provided over the worm portion.

14. A worm gear clutch mechanism as claimed in claim 12, wherein means to move the worm shaft into and out of engagement with the worm wheel comprises a movable housing into which the terminal end of the worm shaft is eccentrically located, the housing being rotatable so that rotation of said housing moves the worm gear shaft in an arc so as to bring it into and out of engagement with the worm wheel.

15. A worm gear clutch mechanism as claimed in claim 14, wherein the terminal end of the worm shaft is provided with a self-aligning radial bearing which locates said terminal end within the eccentric housing.

16. A worm gear clutch mechanism as claimed in claim 8, wherein there is provided a bearing through which the worm shaft extends when said worm shaft is coupled to the input driveshaft via a universal joint or coupling that is located outside the gearbox casing.

17. A worm gear clutch mechanism as claimed in claim 16, wherein the bearing is self-aligning.

18. A worm gear clutch mechanism as claimed in claim 14, wherein the engagement axle or the movable housing is rotated by means of a user operated lever.

19. A worm gear clutch mechanism as claimed in claim 2, wherein the worm gearbox casing is pivotally moveable relative the output shaft or a gear wheel axle to which the worm wheel is mounted.

20. A worm gear clutch mechanism as claimed in claim 1, wherein the gear clutch mechanism is adapted for use with an apparatus such as ground working machine, whereby input drive for the worm shaft is provided by a cross-shaft via a right angle bevel gearbox and a right angle driveshaft extending therefrom and to which the worm shaft is coupled, the tilt axle about which the worm shaft tilts being provided by said cross-shaft.

21. A worm gear clutch mechanism as claimed in claim 20, wherein the worm shaft is cradled in an extended worm arm, the worm arm being movable relative to a worm gearbox casing through which it protrudes.

22. A worm gear clutch mechanism as claimed in claim 21, wherein a flexible seal is provided between the extended worm arm and the worm gearbox casing so that said extended worm arm can move unrestrictedly relative the gearbox casing in order to engage and disengage the worm wheel and/or enable the worm gearbox casing to pivot about a gear wheel axle while preventing dirt or dust from entering said worm gearbox casing.

23. (canceled)
